(19) United States
(12) Patent Application Publication
(10) Pub. No.: US 2004/0121679 A1
(43) Pub. Date: Jun. 24, 2004

(54) Method of reducing static in a spunbond process

(76) Inventor: Albert E. Ortega, Pensacola, FL (US)

Correspondence Address: SALIWANCHIK LLOYD & SALIWANCHIK, A PROFESSIONAL ASSOCIATION, 2421 N.W. 41ST STREET, SUITE A-1, GAINESVILLE, FL, 326066669

(21) Appl. No.: 10/662,492

(22) Filed: Sep. 15, 2003

Related U.S. Application Data
(60) Provisional application No. 60/410,557, filed on Sep. 13, 2002.

(51) Int. Cl. B29B 9/00; B32B 5/02; B32B 27/04; B32B 27/12; D04H 1/00; D04H 3/00

(52) U.S. Cl. 442/110; 442/401; 264/5

(57) ABSTRACT

This invention involves the addition of antistatic agents to the melt of spunbonded processes to improve fabric uniformity and reduce fabric defects.

### FIELD OF THE INVENTION

This invention relates to a method of reducing static in a spunbonded process. The addition of an antistatic agent or agents in the melt allows static to be dissipated providing an advantageous spunbond process.

### BACKGROUND OF THE INVENTION

Most textile processes generate some amount of static due to friction. Static is generated in spinning processes by air passing across filaments and by filaments rubbing over other surfaces. In the production of yarn, this static is commonly dissipated by the addition of finish to the filaments in a filament bundle or threadline. Finishes typically contain lubricating oils, water, antistatic agents and other additives to impart special properties to the fiber or to enhance the ability to process the fiber.

However, in the production of spunbonded fabrics, finish is usually not applied to the filaments. Spunbond processes typically use one or more extruders to melt polymer resins. The melt stream is then filtered and pumped to a spinneret forming filaments that are typically quenched with cool air. Bicomponent or multicomponent spinning methods as described in U.S. Pat. Nos. 3,968,307; 4,052,146; 4,406,850; 4,424,257; 4,424,258; 4,830,904; 5,534,339; 5,783,503; 5,895,710; 6,074,590 and 6,207,276, incorporated by reference, can also be used to make multiconstituent filaments with various properties. In a bicomponent or multicomponent spinning system, the antistatic additive should at least be added to one of the components that will be on the surface of the filaments.

The filaments are attenuated and drawn pneumatically through a jet or slot device and deposited onto a collection surface to form a web. Air is commonly used as the attenuation medium. A vacuum can also be used to move the air through the attenuation device. Static is generated by air rubbing over the filaments in the slot or jet device. Some level of defects and efficiency loss is caused by static. Static can be reduced somewhat but not eliminated by increasing the moisture in the environment surrounding the filaments. Reducing or eliminating the static would be beneficial.

The web is then bonded together to produce a strong, coherent fabric. Filament bonding is typically accomplished either thermally or chemically, i.e., autogenously. Thermal bonding is accomplished by compression of the web of filaments between the nips of a pair of cooperating heating calender rolls. In autogenous bonding of nylon filaments, the web of filaments is transported to a chemical bonding station or “gashouse” which exposes the filaments to an activating agent (i.e., HCl) and water vapor. Water vapor enhances the penetration of the HCl into the filaments and causes them to become tacky and thus amenable to bonding. The web may also be bonded using adhesives to “glue” fibers together to render the fibers cohesive. Upon leaving the bonding station, the web passes between rolls, which compress and bond the web. Even distribution of mass is necessary to provide minimal variation in fabric physical properties and to impart uniformly, good strength properties to the fabric.

High levels of static cause processing problems in both drawing systems listed above. In the jet process, high static levels cause individual filaments or group of filaments to cling to the nearest conductive surface. This creates a small semi circle defect in the fabric. In the slot process, high levels of static have a similar effect. Individual filaments cling to conductive surfaces and interrupt the normal mass flow creating a fabric defect. In both attenuation systems, static affects the formation of the web reducing the uniformity of the fabric appearance.

A process that has little to no static will consistently provide a more uniform fabric at higher efficiencies which is extremely beneficial.

### BRIEF SUMMARY

The subject invention provides a process that adds an antistatic agent or agents in the polymer melt enabling the efficient production of single or multicomponent spunbond fabric with acceptable uniformity. In an embodiment specifically exemplified herein, the spunbonded process uses nylon resin and attenuates filaments with a slot device. In a preferred embodiment, a reduction in static is observed by the addition of about 0.25% of an antistatic additive on the sheath side. In another preferred embodiment, an improved process with very low static is provided by the addition of about 0.75% antistatic additive on the sheath side of nylon filaments in a slot attenuation process.

The addition of antistatic agents benefits various spinning processes including but not limited to single, bicomponent, and multicomponent polymer systems. In bicomponent or multicomponent systems, the antistatic additive should at least be added to one of the components that will be on the surface of the filaments. A slot or jet attenuation device can be used in any of these spin systems to draw the filaments to the desired denier and deposit them onto a surface to form a web. The web can be bonded thermally, ultrasonically or chemically, i.e., autogenously.

### DETAILED DISCLOSURE

In the following detailed description of the subject invention and its preferred embodiments, specific terms are used in describing the invention; however, these are used in a descriptive sense only and not for the purpose of limitation. It will be apparent to the skilled artisan having the benefit of the instant disclosure that the invention is susceptible to numerous variations and modifications within its spirit and scope.

High levels of static cause filaments to hang on any conductive surface until the static on the surface of that filament is dissipated. This interrupts the mass flow creating a fabric defect. Extremely high levels of static cause the filaments to cling to the outlet end of the jet tube creating a section of web with lower mass and a section with higher mass once the static is dissipated and the filaments are released from the tube. In the slot process, high levels of static have a similar effect; individual filaments cling to conductive surfaces and interrupt the normal mass flow creating a fabric defect. Extremely high levels of static frequently interrupt the normal mass flow creating large fabric defects. In both attenuation systems static affects the formation of the web reducing the uniformity of the fabric.

This invention concerns the addition of antistatic agents to spunbond processes to reduce fabric defects and to improve fabric uniformity. In one embodiment, an antistatic additive or a combination of antistatic additives, such as PTSS 1378, available from PolyTech South, Inc. and comprising polycaprolactum (nylon 6), sulfonic acids, C₁₀-C₁₈ alkane and sodium salts is added through an auger into the throat of one extruder used to make nylon 6,6 filaments.

Other antistatic additives including, but not limited to, those described in U.S. Pat. Nos. 6,369,159; 6,150,446; 6,123,990; 5,112,528; 5,744,573; 5,023,036; 5,237,009; 5,342,889; 5,084,504; 5,179,155; 5,659,058; 5,116,897; and 5,025,922 can also be used. These patents are incorporated herein by reference, in their entireties.

Various nylon polymers including, but not limited to, nylon 6; nylon 6,6; nylon 6,10; nylon 6,12; nylon 11; nylon 12; nylon copolymers, and mixtures thereof can be utilized in the process of the present invention.

Antistatic materials that can be used according to the subject invention include, but are not limited to, saccharine; quarternary ammonium salts; homo- and co-polymers of epihalohydrin; N,N,-Bis(hydroxyethyl) alkylamine; chain extended polyoxiranes; aromatic sulfanomides and similar antistatic agents.

In one embodiment, the antistatic agent can be ethylene oxide and at least one heterocyclic co-monomer. In this embodiment, the co-monomer can be in the range of from about 5% to about 95% by weight, wherein the cyclic co-monomer comprises a ring comprising an oxygen atom and at least two carbon atoms. Such compounds include, for example, epihalohydrin or propylene oxide.

Also, the antistatic agent can be a polar antistatic agent comprising a mixture of at least one polar organic compound having at least 5 carbon atoms and a compound having at least 3 heteroatoms. The compounds used in this mixture can be, for example, polyethers, crown ethers, polyols, polyimines, polyamines, polymers derived from pyridine, macrocyclic aza compounds, polysulfides and polyphosphines, and salts of protic acids that are solvated or complexed in a polar organic compound. The salt may be, for example, LiClO₄, LiCF₃SO₃, NaClO₄, LiBF₆, NaBF₆, KBF₆, NaCF₃SO₃, KClO₄, KPF₆, KCF₃SO₃, Ca(ClO₄)₂, Ca(PF₆)₂, Ca(CF₃SO₃)₂, Mg(ClO₄)₂, Mg(CF₃SO₃)₂, Zn(ClO₄)₂, Zn(PF₆)₂ or Ca(CF₃SO₃)₂.

In additional embodiments, the antistatic agent can be styrene polymers; the copolymerization product of ethylene oxide with a heterocyclic monomer or vinyl type monomer; low molecular weight polyether oligomers; carbon particles; trineoalkoxy amino zirconate; trineoalkoxy sulfonyl zirconate; or a compound of the general formula

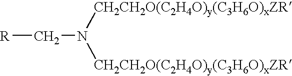

wherein R is a C₁₋₉ alkyl group or hydrogen, Z is a difunctional chain modifier group, R′ is a C₁₋₄ alkyl group or hydrogen and x and y are between about 10 and about 50. In a specific embodiment, the compound can have the formula

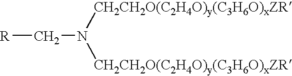

where R is a C₁₋₅ alkyl group or hydrogen, Z is a difunctional chain modifier group, R′ is a C₁₋₄ alkyl group or hydrogen and x and y are each between about 20 and about 40.

In the embodiment depicted by the formulae shown above, the antistatic agent is a linear polyester preferably prepared via the base-catalyzed transesterification of dimethyl azelate with a N-methyldiethanol amine-initiated ethylene oxide/propylene oxide block polymer. The optimum length of propylene oxide and ethylene oxide chains in general has been optimized and the optimum length is known from the literature. The regulation of the chain to the desired length is easily accomplished by one ordinarily skilled in the art by adding proper molar equivalents in a stepwise manner. Chain modifiers are known to those skilled in the art. By way of illustration, the preferred chain modifiers are difunctional. The useful difunctional chain modifiers preferably have acidic or nearly analogously reactive functionality. Preferred chain modifiers are dibasic acids having less than 18 carbon atoms and derivatives thereof. Exemplary modifiers are azelaic acid and alkylazelates. The oxyalkylene chains are preferably end-capped. See, U.S. Pat. No. 5,116,897.

The filaments can be drawn and attenuated, either by a slot or jet device and deposited onto a surface forming a web. The web is then ultrasonically, thermally or chemically bonded. In a specific embodiment, thermal bonding is accomplished by compression of the web of filaments between the nips of a pair of cooperating heating calender rolls set at around 220° C. for nylon filaments.

In autogenous bonding of nylon filaments, the web of filaments is transported to a chemical bonding station or “gashouse” that exposes the filaments to an activating agent (i.e., HCl) and water vapor. Water vapor enhances the penetration of the HCl into the filaments and causes them to become tacky and thus amenable to bonding. The web may also be bonded using adhesives to “glue” fibers together to render the fibers cohesive. Upon leaving the bonding station, the web passes between rolls, which compress and bonds the web.

In a specific embodiment, a reduction in static of about 44% is achieved with the addition of 0.25% of PTSS 1378, available from PolyTech South, Inc. Thus, an antistatic agent comprising polycaprolactum (nylon 6), sulfonic acids, C10-C18 alkane and sodium salts, can be added to the extruder feeding the sheath side of a bicomponent filament spinning system with a slot attenuation system. The same polymer can be fed to an extruder feeding the core side and to an extruder feeding the sheath side of a pilot line capable of bicomponent filament spinning. Higher addition levels give lower static levels up to the point where the majority of the static has been dissipated.

If a single component spinning system with a single extruder is used for this embodiment, it is preferable to add at least 0.25% to the entire melt stream. Levels as low as 0.1% can reduce static; however, the reduction may not be sufficient. Thus, the invention contemplates the addition of at least about 0.2% of the antistatic agent.

The filaments can then be drawn by a slot or jet attenuation device and deposited onto a surface forming a web. The web can then be calendered at 215° C. engraved roll temperature and 205° C. smooth roll temperature.

For a bicomponent or multicomponent spinning process, the addition of an antistatic agent or agents is required only for the portion of the filaments that will be on the surface of the filaments. Adding the antistatic agent or agents to the internal section of a multicomponent filament is not as effective as adding it to the surface of the filament.

Any man-made polymer can be used, such as, but not limited to, polycaprolactum, polyamide, polyester, polyethylene, polypropylene, polylactic acid, poly(trimethylene terephthalate), polyvinyl alcohol, vinyl acetate, nylon 6, nylon 6,6, nylon 10, nylon 11 and nylon 12. Blends and copolymers of man-made polymers can also be used. Also, mixtures, blends or copolymers can be used as taught in U.S. Pat. Nos. 5,431,986 and 5,913,993 both incorporated by reference. In one embodiment, polyethylene, polypropylene, and/or polyester can be added to the nylon material. This produces a softer feel and increases water repellency. In the case of polyethylene, the polyethylene should have a melt index between about 5 grams/10 min and about 200 grams/10 min and a density between about 0.85 grams/cc and about 1.1 grams/cc. The polyethylene can be added at a concentration of about 0.05% to about 20%.

Nylon filaments produced according to the process of the subject invention may be bonded chemically, ultrasonically, or thermally. In one embodiment, HCl gas and water vapor can be applied to achieve bonding as described in U.S. Pat. No. 3,853,659 incorporated by reference. In another embodiment, the filaments may be heated to, for example, between 180° C. and about 250° C. Preferably, the filaments are heated to between about 200° C. and 235° C.

Thus, in a preferred embodiment, the subject invention provides a method of producing a spunbonded nonwoven fabric comprising the steps of forming a melt blend, either in a master batch or a base resin, of polymer and one or more antistatic agents, extruding the blend in the form of a plurality of continuous filaments, directing the filaments through an attenuation device and drawing the filaments, depositing the filaments onto a collection surface to form a web and bonding the filaments of the web. The filaments can be made from, for example, nylon, polyester, acrylic, polyethylene, polypropylene, polybutylene terephtalate, poly(trimethylene terephthalate), polylactic acid polymers or a combination of these polymers.

A further embodiment provides a method of producing a spunbonded nonwoven fabric comprising the steps of forming two or more melt blends, either in a master batch or a base resin, of polymer and one or more antistatic agents, extruding the blends through separate extruders into the form of a plurality of continuous multicomponent filaments, directing the filaments through an attenuation device and drawing the filaments, depositing the filaments onto a collection surface to form a web and bonding the filaments of the web.

The components of the filaments can be made from, for example, nylon, polyester, acrylic, polyethylene, polypropylene, poly(trimethylene terephthalate), polylactic acid polymers, polybutylene terephthalate, ethylene vinyl alcohol, polyvinyl alcohol, vinyl acetate or a combination of these polymers.

A further embodiment provides a method of producing a spunbonded nonwoven fabric comprising the steps of forming one or more melt blends, either in a master batch or a base resin, of polymer and one or more antistatic agents, extruding the blend or blends through separate extruders into the form of a plurality of continuous multicomponent filaments with the blend or blends of polymer and one or more antistatic agents forming a portion of the surface of the filaments, directing the filaments through an attenuation device and drawing the filaments, depositing the filaments onto a collection surface to form a web and bonding the filaments of the web. The components of the filaments can be made from, for example, nylon, polyester, acrylic, polybutylene terephthalate, polyethylene, polypropylene, ethylene vinyl alcohol, polyvinyl alcohol, vinyl acetate, poly(trimethylene terephthalate), polylactic acid polymers or a combination of these polymers; and the attenuation device can be, for example, a slot device or a jet.

For single component, bicomponent and multicomponent slot attenuation spunbound process, the static level as measured one half inch or less below the outlet of the attenuation device is preferably between about −2 kilovolt per inch to about 2 kilovolt per inch. Preferably, at least 5% of the total surface area of all the filaments and each of the filaments produced according to the present invention is a slot device are nylon polymer.

Advantageously, the fabric produced according to the process of the present invention has lower static resistivity and faster static dissipation rates or decay than a fabric produced without antistatic additives.

All patents, patent applications, provisional applications, and publications referred to or cited herein are incorporated by reference in their entirety to the extent they are not inconsistent with the explicit teachings of this specification.

Following are examples which illustrate procedures for practicing the invention. These examples should not be construed as limiting. All percentages are by weight and all solvent mixture proportions are by volume unless otherwise noted.

### EXAMPLE 1

An antistatic additive, PTSS 1378, available from PolyTech South, Inc. and comprising polycaprolactum (nylon 6), sulfonic acids, C₁₀-C₁₈ alkane and sodium salts was added at various levels to a slot pilot line running nylon 6,6 polymer.

The slot pilot line has bicomponent spinning capability. The line was set up to run the same polymer through two extruders and through two polymer delivery manifolds in a sheath-core system. The antistatic additive was added only to the sheath side. This is not a requirement but was done to conserve the amount of antistatic additive since there was a limited supply. Static was initially measured where the filaments exit the slot attenuation device with no antistatic additive present.

The PTSS 1378 antistatic additive was added at 0.25, 0.5, 0.75 and 1 percent and static was measured where the filaments exit the slot attenuation device. Since static charge only resides on the outside of the filament there was no need to supply the antistatic additive to the core side of the filaments. The additive was only added to the sheath side of the bicomponent spinning system. The antistatic additive could be added at the percentages listed in Table 1 to the entire polymer flow stream if only one extruder was used. Static was measured with a hand held static meter, model 212, manufactured by Electro-Tech Systems, Inc. Table 1 lists the results for the different levels of antistatic additive.

TABLE 1
Static measurements for different levels of antistatic additive

| Level of PTSS 1378 | Static where filaments exit the slot attenuation |
|---|---|
| (%) | device (Kilovolts/inch) |
| 0 | 4-7 |
| 0.25 | 2-2.5 |
| 0.50 | 1-1.5 |
| 0.75 | 0.6-1.6 |
| 1.0 | 0.6-1.6 |

The results show a decrease in static up to the addition of 0.75% PTSS 1378 antistatic additive to the sheath side of the filaments. Lowering the static to the level observed provided desirable spinning performance and allowed the production of fabric with acceptable uniformity.

Other antistatic additives can be used as previously referenced. Other polymer resins, copolymer resins, blends of resins or mixtures of resins can also be used.

### EXAMPLE 2

An antistatic additive such as that described in Example 1 can be added to a spunbond process using jet attenuators and running nylon 6,6 polymer or a blend of nylon 6,6 and nylon 6 as described in U.S. Pat. No. 5,431,986. The more rapid dissipation of static in these processes can be used to advantageously reduce defects and improve fabric uniformity.

### EXAMPLE 3

An antistatic additive can be added to the sheath side of a bicomponent spinning process to reduce static as described in Example 1. The core side of the filament can contain any other polymer that can be processed in a bicomponent or multicomponent spinning system to produce acceptable filaments. The attenuation device can be either a slot system as described in Example 1 or a jet system as described in Example 2. The more rapid dissipation of static from the sheath portion of the filament in these processes improves efficiency, reduces defects and improves fabric uniformity.

### EXAMPLE 4

An antistatic additive can be added to the surface of a multicomponent filament spunbond process similar to the system described in Example 1. The core side of the filament can contain any other polymer that can be processed in a multicomponent spinning system to produce acceptable filaments. The attenuation device can be either a slot system as described in Example 1 or a jet system as described in Example 2. The more rapid dissipation of static from the surface portion of the filament in these processes improves efficiency, reduces defects and improves fabric uniformity.

### EXAMPLE 5

The resin with antistatic materials described in Example 1 was added to the slot draw pilot line described in Example 1. These materials were compounded in nylon 6. A master batch of nylon 6, optical brightener and TiO₂ was also mixed with the compounded resin with the antistatic additives and added to the extruder using an auger. Approximately, 1.3% of the master batch resin and 1% of the antistatic resin was added to the sheath side of the bicomponent slot draw pilot line. Humidifiers were turned on in the spinning operations area to increase the humidity.

Static was measured using the hand held static meter, model 212, manufactured by Electro-Tech Systems, Inc. at 0.05 to 0.09 kilovolts per inch. This trial was repeated a second time and static was measured at 0.8 to 1.3 kilovolts per inch. The trial was replicated a third time and the static was measured at 0.5 to 1.7 kilovolts per inch.

Fabric samples were produced at various basis weights. These samples should have lower static resistivity, and faster static dissipation rates or static decay than samples made with no antistatic additives. These samples should also have lower static resistivity and faster static dissipation rates or static decay than commercially existing nylon spunbonded fabrics without antistatic additives.

### EXAMPLE 6

An antistatic additive was added to the slot draw pilot line described in Example 1. This material was compounded in nylon 6,6. The resin is commercially available and it included a sulfonated compound and a phosphorous compound similar to that described in U.S. Pat. No. 5,045,580. A master batch of nylon 6, optical brightener and TiO₂ was also mixed with the commercial resin with the antistatic material and added to the extruder using an auger. The master batch was supplied by Clariant. The mixture was added to the sheath side of the bicomponent slot draw pilot line described in Example 1. This mixture was added at various levels shown in Table 2. The mixture can also be added at the levels shown in Table 2 to the entire polymer stream if only one extruder was used.

Table 2 lists the static measurement results for different levels of antistatic resin. Fabric samples were made at the levels listed in the table.

TABLE 2
Static measurements for different levels of an antistatic additive

| | | Static where filaments |
|---|---|---|
| Level of Resin with | Level Clariant AF | exit the slot attenuation |
| antistatic additive (%) | 03732001 (%) | device (Kilovolts/inch) |
| 1 | 1.3 | 4.5-7.0 |
| 2 | 1.3 | 1.88-2.6 |
| 3 | 1.3 | 0.38-0.53 |
| 3.17 | 1.13 | 0.5 |
| 4 | 1.3 | 0.32-0.44 |
| 4.51 | 0.79 | 0.31-0.42 |
| 5.18 | 1.12 | 0.19-0.26 |
| 6 | 1.3 | 0.17-0.20 |

The results show a substantial decrease in static up to the addition of about 3% of the resin with the antistatic material. Lowering the static to the level observed provided acceptable spinning performance and allowed the production of fabric with desirable uniformity. These fabric samples should have lower static resistivity and faster static dissipation rates or static decay than samples made with no antistatic additives. These samples should also have lower static resistivity and faster static dissipation rates or static decay than commercially existing nylon spunbonded fabrics without antistatic additives.

Other antistatic additives compounded in nylon 6 or nylon 6,6 can also be used as described in previous referenced patents and in U.S. Pat. Nos. 5,814,688 and 5,955,517, incorporated herein by reference. It is not a requirement of the invention to use master batches of the antistatic additive. Antistatic additives can be included in the base resin providing the resin supplier has the capability to incorporate these antistatic additives in the polymerization process.

### EXAMPLE 7

Two other resins with antistatic additives were added to the sheath side of the slot draw pilot line described in Example 1. These materials were compounded in nylon 6,6. These materials can be added to the entire polymer stream if only one extruder was used. It is not a requirement of the invention to use master batches of the antistatic additives. Antistatic additives can be included in the base resin providing the resin supplier has the capability to incorporate these antistatic additives in the polymerization process. Table 3 lists the static measurement results for different levels of antistatic resins.

TABLE 3
Static measurements for different levels of a third and fourth
antistatic additive

| | | Static where filaments |
|---|---|---|
| Resin with antistatic | Level of Resin with | exit the slot attenuation |
| additive (%) | antistatic additive (%) | device (Kilovolts/inch) |
| None | 0 | 2-14 |
| 3A46 | 2 | 1.5-4.0 |
| 3A46 | 4 | 0.8-1.3 |
| 3A46 | 6 | 0.2-1.0 |
| 422 | 3 | (−0.47)-(−0.38) |

The results show a substantial decrease in static up to the addition of about 6% of the 3A46 resin with the antistatic materials. The results also show a low static level for the addition of 3% of resin 422.

It should be understood that the examples and embodiments described herein are for illustrative purposes only and that various modifications or changes in light thereof will be suggested to persons skilled in the art and are to be included within the spirit and purview of this application.

I claim:

1. A method of producing a spunbonded nonwoven fabric comprising the steps of forming a melt blend of at least one polymer and at least one antistatic agent, extruding said blend in the form of a plurality of filaments, directing the filaments through an attenuation device and drawing the filaments to orient them, depositing the filaments onto a collection surface to form a web and bonding the filaments of the web.

2. The method, according to claim 1, wherein the filaments comprise nylon, polyester, acrylic, polyethylene, polypropylene, polybutylene terephthalate, poly(trimethylene terephthalate), or polylactic acid polymers; or a combination of these polymers.

3. The method, according to claim 2, wherein the filaments comprise nylon 6; nylon 6,6; nylon 6,10; nylon 6,12; nylon 11; nylon 12; or nylon copolymers; or a combination of these nylon polymers.

4. The method, according to claim 1, wherein said method utilizes two or more melt blends of polymer.

5. The method, according to claim 1, wherein the attenuation device is a slot device.

6. The method, according to claim 1, wherein the attenuation device is a jet.

7. The method, according to claim 1, wherein said method utilizes an antistatic material comprising an agent selected from the group consisting of: saccharine; quarternary ammonium salts; homo- and co-polymers of epihalohydrin; N,N,-Bis(hydroxyethyl) alkylamine; chain extended polyoxiranes; aromatic sulfanomides; styrene polymers; the copolymerization product of ethylene oxide with a heterocyclic monomer or vinyl type monomer; low molecular weight polyether oligomers; carbon particles; trineoalkoxy amino zirconate; trineoalkoxy sulfonyl zirconate; and compounds of the general formula 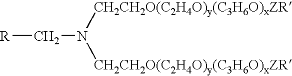
wherein R is a C₁₋₉ alkyl group or hydrogen, Z is a difunctional chain modifier group, R′ is a C₁₋₄ alkyl group or hydrogen and x and y are between about 10 and about 50.

8. The method, according to claim 7, wherein R is a C₁₋₅ alkyl group or hydrogen, Z is a difunctional chain modifier group, R′ is a C₁₋₄ alkyl group or hydrogen and x and y are each between about 20 and about 40.

9. The method, according to claim 1, wherein said antistatic agent comprises ethylene oxide and at least one heterocyclic co-monomer.

10. The method, according to claim 1, wherein said antistatic agent comprises at least one polar organic compound having at least 5 carbon atoms and a compound having at least 3 heteroatoms.

11. The method, according to claim 10, wherein the antistatic material comprises one or more of the group consisting of polyethers, crown ethers, polyols, polyimines, polyamines, polymers derived from pyridine, macrocyclic aza compounds, polysulfides and polyphosphines, and salts of protic acids that are solvated or complexed in a polar organic compound.

12. The method, according to claim 1, wherein the static level measured at about one half inch below the outlet of the slot attenuation device is between about −2 kilovolt per inch and about 2 kilovolt per inch.

13. The method, according to claim 1, wherein the static level measured at about one half inch below the outlet of the slot attenuation device is between about −1 kilovolt per inch and about 1 kilovolt per inch.

14. The method, according to claim 1, wherein at least about 5% of the surface area of each filament is made of a nylon polymer.

15. The method, according to claim 1, wherein at least about 5% of the total surface area of all filaments is made of a nylon polymer.

16. The method, according to claim 1, wherein said method utilizes an antistatic agent that comprises polycaprolactum, a sulfonic acid, a C₁₀-C₁₈ alkane, and sodium salts.

17. A method of producing a spunbonded nonwoven fabric comprising the steps of forming one or more melt blends of polymer and one or more antistatic agents either in a master batch or a base resin, extruding said blend or blends through separate extruders into the form of a plurality of multicomponent filaments with the blend or blends of polymer and one or more antistatic agents forming a portion of the surface of the filaments, directing the filaments through an attenuation device, drawing the filaments to orient them, depositing the filaments onto a collection surface to form a web and bonding the filaments of the web.

18. The method according to claim 17, wherein the filaments comprise nylon, polyester, acrylic, polybutylene terephthalate polyethylene, polypropylene, ethylene vinyl alcohol, polyvinyl alcohol, vinyl acetate, poly(trimethylene terephthalate), or polylactic acid polymers; or a combination of these polymers.

19. The method, according to claim 17, wherein the filaments comprise nylon 6; nylon 6,6; nylon 6,10; nylon 6,12; nylon 11; nylon 12; or nylon copolymers; or a combination of these nylon polymers.

20. The method, according to claim 17, wherein the attenuation device is a slot device.

21. The method, according to claim 17, wherein the attenuation device is a jet.

22. The method, according to claim 17, wherein said method utilizes an antistatic material comprising an agent selected from the group consisting of: saccharine; quarternary ammonium salts; homo- and co-polymers of epihalohydrin; N,N,-Bis(hydroxyethyl) alkylamine; chain extended polyoxiranes; aromatic sulfanomides; styrene polymers; the copolymerization product of ethylene oxide with a heterocyclic monomer or vinyl type monomer; low molecular weight polyether oligomers; carbon particles; trineoalkoxy amino zirconate; trineoalkoxy sulfonyl zirconate; and compounds of the general formula 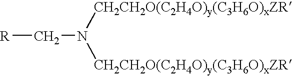
wherein R is a C₁₋₉ alkyl group or hydrogen, Z is a difunctional chain modifier group, R′ is a C₁₋₄ alkyl group or hydrogen and x and y are between about 10 and about 50.

23. The method, according to claim 22, wherein R is a C₁₋₅ alkyl group or hydrogen, Z is a difunctional chain modifier group, R′ is a C₁₋₄ alkyl group or hydrogen and x and y are each between about 20 and about 40.

24. The method, according to claim 17, wherein the static level measured at about one half inch below the outlet of the slot attenuation device is between about −2 kilovolt per inch and about 2 kilovolt per inch.

25. The method, according to claim 17, wherein the static level measured at about one half inch below the outlet of the slot attenuation device is between about −1 kilovolt per inch and about 1 kilovolt per inch.

26. The method, according to claim 17, wherein at least about 5% of the surface area of each filament is made of a nylon polymer.

27. The method, according to claim 22, wherein at least about 5% of the total surface area of all filaments is made of a nylon polymer.

28. The method, according to claim 17, wherein said method utilizes an antistatic agent that comprises polycaprolactum, a sulfonic acid, a C₁₀-C₁₈ alkane, and sodium salts.

29. A single component, bicomponent or multicomponent spunbond process where the static level measured at one half inch below the outlet of the slot attenuation device is between about −2 kilovolt per inch and about 2 kilovolt per inch.

30. The processes, according to claim 29, wherein at least 5% of the surface area of each filament is made of a nylon polymer.

31. The processes, according to claim 29, wherein at least 5% of the total surface area of all filaments is made of a nylon polymer.

32. The processes, according to claim 29, wherein the static level measured one half inch or less below the outlet of the attenuation device is between about −1 kilovolt per inch and about 1 kilovolt per inch.

33. A non-woven fabric made with a process using one or more antistatic agents, wherein said fabric has lower static resistivity and faster static dissipation rates or static decay than a fabric made similarly without antistatic additives.
